(19) United States
(12) Patent Application Publication
(10) Pub. No.: US 2007/0117069 A1
(43) Pub. Date: May 24, 2007

(54) Masonry arrangement sample panels

(76) Inventor: Theodore Marcopolus, Sussex, NJ (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 11/599,657

(22) Filed: Nov. 14, 2006

Related U.S. Application Data
(60) Provisional application No. 60/736,263, filed on Nov. 14, 2005.

(51) Int. Cl. G09B 25/00

(52) U.S. Cl. 434/74

(57) ABSTRACT

A panel is provided having a variety of stones adhered in specific patterns. The stones adhered to the panel are the same as the stones that are applied to an actual wall surface but are scaled down in size to allow them to be fixed on the panel for ease of carrying and portability. The panel can have one or more separate arrangements of stones. The stones can be of different colors, textures, sizes or patterns. A handle is provided on the panel to facilitate carrying.

This application claims the benefit of U.S. Provisional Application Ser. No. 60/736,263, filed on Nov. 14, 2005.

### FIELD OF THE INVENTION

This invention relates to display materials, and more particularly, sample panels to provide a scaled-down view of bricks/stones for application on a surface.

### BACKGROUND

Stone wall masonry is a very popular way of decorating walls on the interior or exterior of a residential or commercial building. The stones utilized in covering a wall surface or the exterior of a house are, however, typically very large and heavy.

When a property owner is designing a new building or redecorating an existing building, it is often desirable to view samples of the stones being considered for installation, e.g., the styles of stones that are available, the sizes and colors of the stones, the textures of the stones, etc. However, since the stones are large and heavy, it is difficult for a contractor, builder or designer to carry them around. While photographs and/or computer designs can be used to provide a visual of a finished stone wall the photograph or other visual display does not permit the homeowner to touch the stones that will be used to cover the surface. Moreover, most property owners prefer to see actual samples of the stones themselves in the environment in which the stones will ultimately be installed. Many stones have specific textures and appearances and thus providing a homeowner with the ability to view the actual stones and to feel them is highly desirable.

### SUMMARY OF THE INVENTION

The present invention provides a scaled down display panel that will allow a homeowner to view and feel the actual stone layout/arrangement prior to installation, and which is easily portable by a contractor, builder, salesperson or the like.

Accordingly, a display is provided, comprising a panel, and two or more stones provided on the panel, wherein the two or more stones are the same as the stones to be used during construction. The two or more stones can be scaled down in size compared to the actual stones used during construction, and can be shaped to fit next to one another on the panel.

Further, a kit is provided, comprising one or more panels having two or more stones provided on each panel, wherein the two or more stones on each panel are the same as the stones to be used during construction, and a box for holding the one or more panels. The kit can have one or more compartments provided for in the one or more panels that have removable stones set therein.

A method of displaying a stone arrangement for building construction is also provided, the method comprising providing one or more stone arrangements on a panel, wherein the one or more stone arrangements are the same as the stone arrangement to be used during construction, and displaying the panel to an owner for the owner to choose the stone arrangement desired.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWING

These and other features, aspects, and advantages of the apparatus and methods of the present invention will become better understood with regard to the following description, appended claims, and accompanying drawing where:

FIG. 1 is a top view of one embodiment of a display panel having a stone layout or arrangement.

### DETAILED DESCRIPTION OF THE INVENTION

Although this invention is applicable to numerous and various types of displays, it has been found particularly useful in the environment of displays for stone layouts for building construction. Therefore, without limiting the applicability of the invention to the above, the invention will be described in such environment.

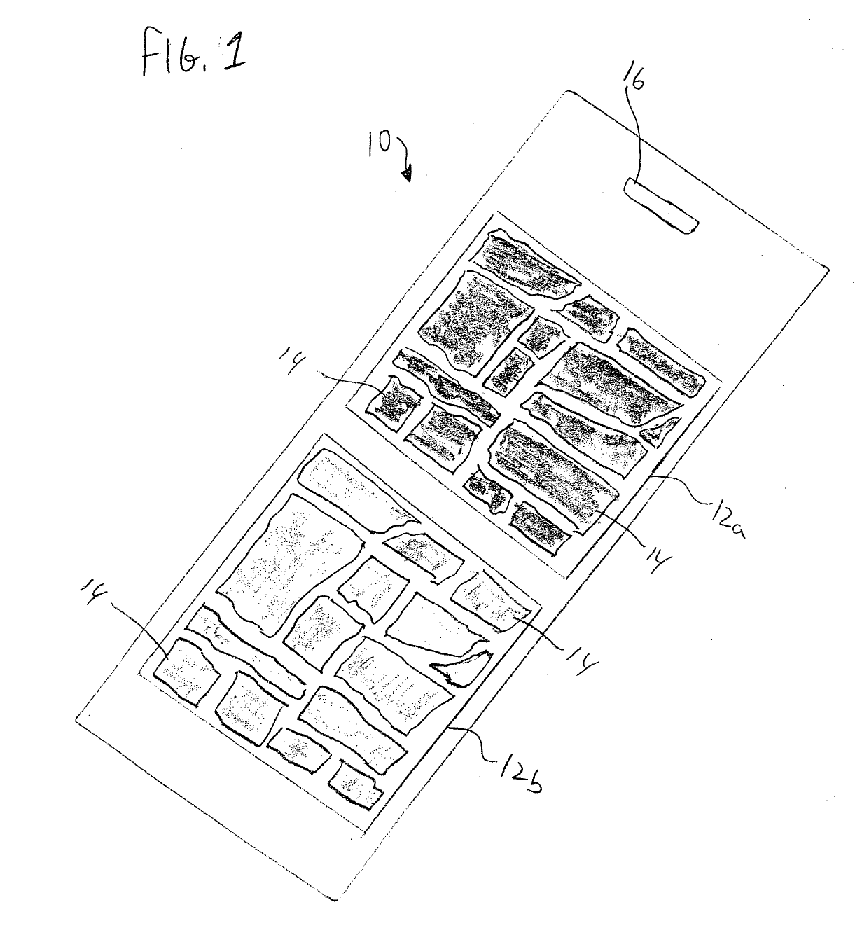

In one embodiment, as shown in FIG. 1, there is provided a board or panel 10 upon which a variety of stones 14 are adhered in specific patterns. The stones 14 adhered to the panel 10 are typically the “same” as the stones that are applied to an actual wall surface but are scaled down in size to allow them to be fixed on the panel for ease of carrying and portability. By “same” it does not mean that the stones provided on the panel 10 have to be the actual stones used for construction, but that similar stones in a similar layout as provided on the panel 10 are used during the actual construction of the building/home. These stones may also have the same texture, color and shape as the stones that are used during the actual construction of the building/home. The stones may be scaled down in any ratio, and can be preferably scaled down approximately ⅔ in size.

The exemplary panel 10 can have two separate arrangements 12a, 12b with stones 14 arranged thereon is illustrated in FIG. 1. The panel can have one or more separate arrangements, and two different arrangements 12a and 12b are shown for purposes of FIG. 1. Arrangement 12a can be a pattern of dark colored stones 14, while arrangement 12b can be a similar pattern using lighter colored stones 14. Arrangements 12a and 12b can be different patterns with similar stones, or similar patterns with different stones, or different patterns with different stones and are not limited to the above. Further, each arrangement 12a or 12b may provide different stones in the arrangement itself, if that is the design required on the panel. A handle 16 may be provided on panel 10 to facilitate carrying.

The stones 14 adhered to the panel 10 can be arranged or styled just as they would appear on the larger or actual wall surface. In this manner, the stones 14 can be shaped to “fit” next to one another, as shown in FIG. 1, and are typically of a similar color scheme and texture as desired by the homeowner or building owner. The panel 10 with adhered stones 14 will allow the homeowner or building owner to get a scaled down view of how the stones 14 and the pattern will appear when applied on the larger or actual wall surface. The homeowner or building owner will also be able to feel the stones and see the actual arrangement before the actual construction and installation takes place.

It is contemplated that the panel 10 of the present invention can be custom-created based on criteria provided by the homeowner. The panel 10 may also be provided with more than one pattern arrangement and may include a handle or channel through the panel to facilitate holding and carrying.

In an alternative embodiment, the panels described herein can be part of a kit which is easily transportable to different sites. The kit would comprise a box capable of holding one or more sample panels therein. Such a kit would be significantly more convenient for a contractor to bring to a prospective customer's home than standard, full-sized samples. The panels could be configured to also hold a number of different types of “free” stones, i.e., stones not adhered to the panels. The panel would be provided with various configurable compartments to maintain the “free” stones. The panels could have removable stones so the stones can be removed and other stones can be placed on the compartments of the panels. The kit can also be provided with a telescoping handle and wheels to facilitate transporting of the kit from site to site.

The present invention provides several advantages that solve the problems with prior art methods. The panel of the present invention allows the homeowner or building owner to see the actual stones in the actual layout as would be provided during construction and installation of the building or home. It could provide different patterns, stones, textures so the homeowner or building owner can determine which arrangement to choose.

The above description of the present invention is only the preferred embodiment of the invention. Embodiments may include any currently or hereafter-known versions of the elements described herein. Different types, sizes and colors of stones can be used. Different textures can be provided for similar of different stones. The panel can have one or more patterns or arrangements, and is not limited to the above description. Although the invention was described in regard to building stones, it is understood that the invention can be used for any type or rock, stone or other similar material used for building construction in accordance with the same principles described herein, and is not limited to stones.

While the present invention has been particularly described and illustrated with respect to preferred embodiments thereof, it will be understood by those skilled in the art that the foregoing and other changes in forms and details may be made without departing from the spirit and scope of the present invention. It is therefore intended that the present invention is not limited to the exact forms and details described and illustrated.

What is claimed is:

1. A display, comprising:
a panel; and
two or more stones provided on the panel; wherein the two or more stones are substantially the same as the stones to be used during construction.

2. The display of claim 1, wherein the two or more stones are scaled down in size compared to the actual stones used during construction.

3. The display of claim 1, wherein the two or more stones are shaped to fit next to one another on the panel.

4. The display of claim 1, wherein the two or more stones are provided in a specific pattern.

5. The display of claim 1, wherein the two or more stones are provided for in a first arrangement, and further comprising:
a second arrangement having two or more stones.

6. The display of claim 5, wherein the first arrangement is provided for in a first pattern and the second arrangement is provided for in a second pattern.

7. The display of claim 5, wherein the first arrangement comprises stones of a lighter color and the second arrangement comprises stones of a darker color.

8. The display of claim 1, further comprising:
a handle provided on the panel.

9. The display of claim 1, wherein the two or more stones have substantially the same texture as the stones used during the actual construction of the building/home.

10. The display of claim 1, wherein the two or more stones have substantially the same shape as the stones used during the actual construction of the building/home.

11. The display of claim 1, wherein the two or more stones have substantially the same color as the stones used during the actual construction of the building/home.

12. A kit, comprising:
one or more panels having two or more stones provided on each panel, wherein the two or more stones on each panel are substantially the same as the stones to be used during construction; and
a box for holding the one or more panels.

13. The kit of claim 12, further comprising:
one or more compartments provided for in the one or more panels that have removable stones set therein.

14. The kit of claim 13, further comprising:
one or more stones not attached to the panels, which can be placed in the compartments of the one or more panels.

15. The kit of claim 12, further comprising:
a handle and wheels for facilitating the transportation of the kit.

16. A method of displaying a stone arrangement for building construction, comprising:
providing one or more stone arrangements on a panel, wherein the one or more stone arrangements are the same as the stone arrangement to be used during construction; and
displaying the panel to an owner for the owner to choose the stone arrangement desired.
